(19) United States
(12) Patent Application Publication
(10) Pub. No.: US 2014/0287258 A1
(43) Pub. Date: Sep. 25, 2014

(54) METHOD FOR AFFIXING A METAL SHEET TO A CARBON STRUCTURE USING A BRAZING AND SOLDERING PROCESS

(71) Applicants: Johnson Electric S.A., Murten (CH); Shenzhen Joint Welding Material Co., Ltd., Shenzhen (CN)

(72) Inventors: Jianjun GUO, Shenzhen (CN); Zhiping ZOU, Shenzhen (CN); Zonghui ZHENG, Shenzhen (CN); Chihang TO, Hong Kong (CN)

(73) Assignees: Johnson Electric S.A., Murten (CH); Shenzhen Joint Welding Material Co., Ltd., Shenzhen (CN)

(21) Appl. No.: 14/221,156

(22) Filed: Mar. 20, 2014

(30) Foreign Application Priority Data
Mar. 20, 2013 (CN) 201310090190.6
Mar. 20, 2013 (CN) 201310091496.3

(51) Int. Cl. B23K 1/19; B32B 15/04

(52) U.S. Cl. CPC B23K 1/19; B32B 15/043
USPC 428/576; 228/122.1

(57) ABSTRACT

An assembly comprises a carbon structure (10), a metal sheet (40), a brazing layer (20) disposed on a surface of the carbon structure (10). The brazing layer (20) is formed by brazing a brazing material on the surface of the carbon structure (10), and a solder layer (30) disposed on a surface of the brazing layer (20) and binding the metal sheet (40) to the brazing layer (20). A method for affixing a metal sheet (40) to a carbon structure (10) and a method for metalizing a surface of a carbon structure (10) are also provided.

### CROSS REFERENCE TO RELATED APPLICATION(S)

This application claims the benefit of Chinese patent application serial no. 201310090190.6 and no. 201310091496.3, both filed on Mar. 20, 2013. The entire content of the aforementioned patent applications are hereby incorporated by reference for all purposes.

### BACKGROUND

Graphite is required to be connected to a metal sheet in certain products, such as a commutator. In the current industry, a nickel or copper metal layer is formed on the surface of the graphite through electroplating or ion sputtering. Subsequently, a solder material having a melting point of 450 degrees Celsius (° C.) or less, such as tin, is used to solder a copper sheet on the graphite. However, due to there being no metallurgical bond between the metal layer and graphite, the connection between the metal layer and graphite in a commutator manufactured using this method lack sufficient strength.

Alternatively, a brazing material with a melting point of 450° C. or higher is applied between the graphite and the copper sheet, where the graphite, copper sheet, and brazing material are placed in a high temperature furnace and brazed, fixing the copper sheet to the graphite. However, due to the large differences of coefficient of thermal expansion between copper and graphite, the brazing process may cause many large cracks to form in the graphite. In addition, the copper of the copper sheet may be weakened or softened by the high temperature brazing process, making it less suitable for mounting the coils.

Accordingly, there exists a need for a method for connecting a graphite structure and a metal sheet that addresses the above problems.

### SUMMARY

Some embodiments are directed at method for affixing a metal sheet to a carbon structure, such as a graphite structure, which includes: applying a brazing material to a surface of the carbon structure; brazing the brazing material and the carbon structure to form a brazing layer on the surface of the carbon structure; and soldering the metal sheet to the brazing layer. Some embodiments are directed at an assembly comprising a carbon structure and a metal sheet including a brazing layer disposed on a surface of the carbon structure; and a solder layer disposed on a surface of the brazing layer and binding the metal sheet to the brazing layer. Some embodiments are directed at method for metalizing a surface of a carbon structure which includes the steps of: applying a brazing material to a surface of the carbon structure; and brazing the brazing material and the graphite structure.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a cross-section of a graphite structure, a metal sheet, and a binding layer connecting the graphite structure and the metal sheet in accordance with some embodiments.

FIGS. 2A and 2B are flowcharts illustrating a process for connecting a graphite structure and a metal sheet by a binding layer in accordance with some embodiments.

### DETAILED DESCRIPTION

Various features are described hereinafter with reference to the figures. It shall be noted that the figures are not necessarily drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

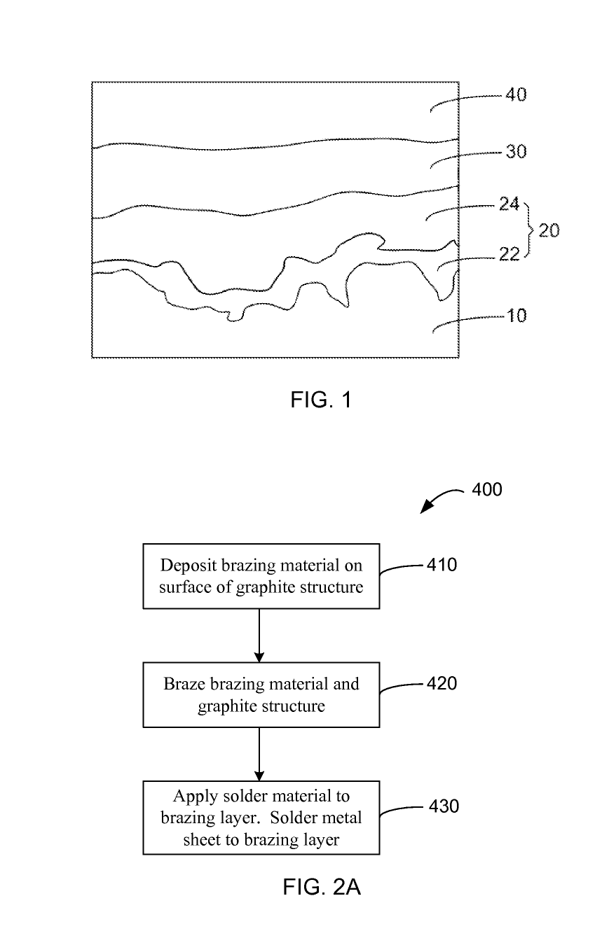

FIG. 1 illustrates a cross-section of an assembly having a carbon structure 10 in accordance with some embodiments. In a preferred embodiment, carbon structure 10 is a graphite structure 10. For the purposes of this specification, carbon structure 10 is hereinafter referred to as graphite structure 10.

The assembly further comprises a metal sheet 40 and a binding layer between graphite structure 10 and metal sheet 40 and comprised of a brazing layer 20 and a solder layer 30 in accordance with some embodiments. In various embodiments, metal sheet 40 may be made of copper, silver, aluminum, or other types of metals.

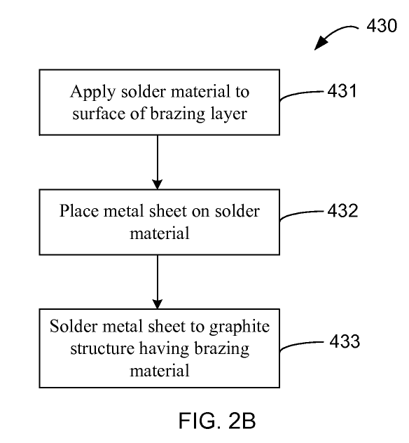

FIG. 2A is a flowchart illustrating a process 400 of affixing a metal sheet to a graphite structure in accordance with some embodiments of the present invention. By way of example, FIG. 1 illustrates a cross sectional view of the metal sheet 40 affixed to the graphite structure 10 through the process 400. Process 400 starts at 410, by applying a brazing material to a surface of graphite structure 10. The brazing material may be applied to the graphite structure 10 through screen printing or spraying. In some embodiments, graphite structure 10 is cleaned prior to applying the brazing material. The cleaning process may comprise one or more of the following: grinding the surface of graphite structure 10 that is to receive the brazing material, washing graphite structure 10 using alcohol and a means for generating ultrasonic waves, immersing graphite structure 10 in acetone, and/or drying graphite structure 10.

Subsequently at 420, the graphite structure 10 with brazing material applied thereon is brazed. In some embodiments, brazing may be done using a vacuum furnace. The vacuum furnace may be configured to have a vacuum degree of 1.0×10⁻¹ Pascals (Pa) or higher (e.g., 1.0×10⁻³ Pa), and a temperature of 800 degrees Celsius (° C.) or higher, wherein graphite structure 10 and brazing material are placed in the furnace for a period of between 10 minutes and 30 minutes. However, it is understood that in some embodiments, the brazing period may exceed 30 minutes. It is understood that in other embodiments, brazing may done in other types of furnaces. As shown in FIG. 1, the applied brazing material forms a brazing layer 20 over graphite structure 10.

At 430, metal sheet 40 is soldered to a surface of the brazing layer 20 on brazed graphite structure 10. FIG. 2B is a flowchart illustrating a soldering process that may correspond to soldering step 430 in flow chart 400 in accordance with some embodiments. At 431, a solder material is applied on a surface of brazing layer 20 on brazed graphite structure 10. In some embodiments, the solder material may be in the form of a paste, powder, or slurry, and be applied to brazing layer 20 through screen printing. In other embodiments, the solder material is a solid piece or sheet placed on a surface of metal sheet 40, with a shape corresponding to that of the surface of metal sheet 40.

Subsequently at 432, metal sheet 40 is placed on top of the solder material. At 433, graphite structure 10 having brazing layer 40, the solder material, and metal sheet 40 are placed in a soldering environment for certain amount of time. In some embodiments, the soldering environment is configured to have a temperature between 130° C. and 350° C., and the amount of time is configured to be between 2 minutes and 10 minutes. Thus, metal sheet 40 is soldered to brazing layer 20 of graphite structure 10 with a solder layer 30 formed between metal sheet 40 and brazing layer 20, as shown in FIG. 1.

While FIG. 2B illustrates a particular soldering process 430 that may be used in some embodiments, it is understood other types of soldering processes may be used instead in various other embodiments. For example, metal sheet 40 may be soldered to graphite structure 10 through a hand soldering process using an electric iron.

Referring to FIG. 1, after the brazing material and graphite structure 10 are brazed in step 420, active elements in the brazing material (such as titanium, chromium, zirconium, and/or silicon) will undergo chemical reactions with the carbon element on the surface of graphite structure 10, forming brazing layer 20 the surface of graphite structure 10. Brazing layer 20 comprises two layers: a reaction layer 22 adjacent to an interior of graphite structure 10, formed by chemical reactions between the brazing material and carbon of graphite structure 10, and a binding layer 24 near the surface of graphite structure 10 formed mostly of the brazing material through a thermal process.

Due to metallurgical reactions, reaction layer 22 is tightly bound to the carbon in graphite structure 10 and to binding layer 44, which comprises predominantly metal elements. Thus, the brazed brazing material on the surface of graphite structure 10 forms a strong metal layer 22 strongly bonded to the carbon graphite structure 10 through chemical reactions and binding layer 24 tightly bonded to reaction layer 22, thereby metalizing the surface of graphite structure 10 and facilitating the subsequent binding of metal layer 40 to graphite structure 10 by soldering in step 430.

In addition, because metal sheet 40 is soldered to brazing layer 20 in a comparatively lower temperature environment, the process does not soften metal sheet 40, and avoids the formation of cracks in graphite structure 10 that would otherwise formed due to the large difference in coefficients of thermal expansion between the metal of metal sheet 40 and the graphite of graphite structure 10.

Various specific embodiments are described herein below. In various embodiments, different materials and configurations may be used. It is understood the following embodiments are meant to illustrate, and are not intended the limit the scope of the claims.

### Embodiment 1

In a first embodiment, metal sheet 40 is made of copper, while the brazing material includes a titanium-copper-silver mixture. For example, the brazing material mixture may comprise by weight approximately 69% silver, 27% copper, and 4% titanium. The brazing material is applied to graphite structure 10 using silk screen printing. The silk screen printing process preferably uses a polyester mesh having a thickness of 0.5 millimeters (mm) or less, such that the mesh will be able to exhibit desirable elasticity during the printing process.

At 420, in accordance with the first embodiment, graphite structure 10 having the brazing material is placed in a vacuum furnace configured to have a vacuum degree between 1.0×10⁻¹ Pa and 4.0×10⁻² Pa, and a temperature between 800° C. and 900° C., for a period of time between 13 minutes and 17 minutes. In a preferred embodiment, the vacuum furnace is configured to have a vacuum degree of approximately 6.0×10⁻² Pa, a temperature of 850° C., and a furnace time of 15 minutes. In some embodiments, upon placement of graphite structure 10 in the furnace, the temperature of the furnace is configured to rise at rate of approximately 10° C. per minute until the target temperature of 850° C. is reached. The temperature in the furnace is maintained at the target temperature for the furnace time (e.g., 15 minutes). Graphite structure 10 is subsequently cooled.

The solder material used at 430 comprises a tin paste applied to the surface of brazing layer 20 through screen printing. The screen printing process preferably uses a steel mesh screen having a thickness of 1 mm or less, in order to achieve the desirable flexibility of the mesh during the printing of the solder material. The brazed graphite structure 10, paste, and copper sheet 40 are placed in a soldering environment with a temperature of between 250° C. and 350° C. for a period of time between 2 minutes and 4 minutes, and subsequently cooled. Thus copper sheet 40 is soldered to the surface of brazing layer 20, with the solder paste forming solder layer 30.

### Embodiment 2

In a second embodiment, metal sheet 40 is made of copper, and the brazing material is a BNi₂ type brazing material in accordance with American Welding Society (AWS) guidelines applied using a spraying method.

At 420, graphite structure 10 comprising the layer of BNi₂ type brazing material is placed in a vacuum furnace for between 25 minutes and 35 minutes, wherein the furnace is configured to have a vacuum degree between 2.0×10 ⁻² Pa and 8×10⁻³ Pa and a temperature between 1050° C. and 1150° C. In a preferred embodiment, the vacuum degree and temperature of the furnace are configured to be 1.00×10⁻² Pa and 1100° C., respectively, and graphite structure 10 is placed in the furnace for 30 minutes. In some embodiments, upon placement of graphite structure 10 within the furnace, the temperature of the furnace is configured to rise at rate of approximately 15° C. per minute until the target temperature of 1100° C. is reached, upon which the furnace time of 30 minutes begins. Graphite structure 10 is subsequently cooled.

At 430, a solder paste comprising a slurry of tin (Sn) and bismuth (Bi) is applied to brazing layer 20. In some embodiments, the tin-bismuth slurry comprises by weight approximately 42% tin and 58% bismuth (Sn-58Bi). The solder paste may be applied through screen-printing, which preferably uses a steel mesh screen having a thickness of 1 mm or less, in order to achieve desirable flexibility of the mesh during printing.

The brazed graphite structure 10, paste, and copper sheet 40 are placed in a soldering environment with a temperature of between 150° C. and 250° C. for between 4 minutes and 6 minutes, and subsequently cooled. Thus copper sheet 40 is soldered to the surface of brazing layer 20, with the solder paste forming a solder layer 30.

### Embodiment 3

In a third embodiment, metal sheet 40 comprises silver, and the brazing material may comprise titanium, zirconium, copper, and nickel uniformly sprinkled on a surface of graphite structure 10. In some embodiments, the brazing material comprises by weight approximately 40% titanium, 20% zirconium, 20% copper, and 20% nickel.

At 420, graphite structure 10 comprising the layer of brazing material is placed in a vacuum furnace for between 20 and 30 minutes, wherein the furnace is configured to have a pressure between 1.0×10⁻² Pa and 3×10⁻³ Pa and a temperature between 900° C. and 1000° C. In a preferred embodiment, the pressure is configured to be 8×10⁻³ Pa and the temperature to be 950° C., wherein graphite structure 10 having the brazing material is placed in the furnace for 20 minutes. In some embodiments, upon placement of graphite structure 10 within the furnace, the temperature of the furnace is configured to rise at rate of approximately 15° C. every minute until 950° C. is reached, upon which the furnace time of 30 minutes begins.

At 430, a solder piece with a shape corresponding to that of graphite structure 10 is placed over brazing layer 40. The use of a solid solder piece may allow for ease of assembly. The solder piece may comprise tin and copper, such as 98% tin, 2% copper (Sn-2Cu).

The brazed graphite structure 10, solder piece, and silver sheet 40 are placed in a soldering environment with a temperature of between 300° C. and 350° C. for between 7 minutes and 10 minutes, and subsequently cooled. Thus silver sheet 40 is soldered to the surface of brazing layer 20, with the solder paste forming a solder layer 30.

### Embodiment 4

In a fourth embodiment, metal sheet 40 is made of aluminum. A BNi₂ type brazing material in accordance with AWS guidelines is used. The brazing material may be applied to graphite structure 10 using silk screen printing. The silk screen printing process preferably uses a polyester mesh having a thickness of 0.5 mm or less, such that the mesh will be able to exhibit better elasticity during the printing process.

At 420, graphite structure 10 comprising the layer of BNi₂ type brazing material is placed in a vacuum furnace for between 25 minutes and 35 minutes, wherein the furnace is configured to have a vacuum degree between 3.0×10⁻³ Pa and 1.0×10⁻³ Pa and a temperature between 1100° C. and 1200° C. In a preferred embodiment, the vacuum degree is configured to be 1.0×10⁻³ Pa and the temperature to be 1200° C., wherein graphite structure 10 having the brazing material is placed in the furnace for 20 minutes. In some embodiments, upon placement of graphite structure 10 in the furnace, the temperature of the furnace is configured to rise at rate of approximately 20° C. per minute until 1200° C. is reached, upon which the furnace time of 20 minutes begins.

At 430, a solder piece with a shape corresponding to that of graphite structure 10 is placed over brazing layer 20. The use of a solid solder piece may allow for ease of assembly compared to applying a solder paste or slurry. The solder piece may comprise tin and copper, such as a 98% tin, 2% copper (Sn-2Cu).

The brazed graphite structure 10, paste, and aluminum sheet 40 are placed in a soldering environment with a temperature of between 270° C. and 300° C. for between 3 and 5 minutes, and subsequently cooled. Thus aluminum sheet 40 is soldered to the surface of brazing layer 20, with the solder paste forming a solder layer 30.

### Embodiment 5

In a fifth embodiment, metal sheet 20 comprises copper. The brazing material is a BNi₇ brazing material in accordance with AWS guidelines, which is deposited on a surface of graphite structure 10 using screen printing, wherein the screen printing process preferably uses a polyester mesh having a thickness of 0.5 mm or less.

Graphite structure 10 having BNi₇ brazing material applied thereon is placed in an ammonia decomposition mesh belt furnace, with a belt speed of 1-8 meters per second (m/s), and a maximum temperature of between 800° C. and 1000° C. In a preferred embodiment, the belt speed of the mesh belt furnace is configured to be approximately 0.4 m/s, and the maximum temperature to be 1000° C. In some embodiments, the mesh belt furnace is a protective atmosphere or controlled atmosphere furnace. The protective atmosphere may include nitrogen, hydrogen, argon, helium, carbon monoxide, carbon dioxide, or a mixture of thereof, wherein different gases may correspond to different temperatures. Thus it is understood that temperature range is not limited to that described above.

At 440, a solder piece with a shape corresponding to that of graphite structure 10 is placed over brazing layer 40. The use of a solid solder piece may allow for ease of assembly compared to applying a solder paste or slurry. The solder piece may comprise tin and indium, such as a 49% tin, 51% indium (Sn-51In).

The brazed graphite structure 10, paste, and copper sheet 40 are placed in a soldering environment with a temperature of between 130° C. and 230° C. for between 3 and 5 minutes, and subsequently cooled. Thus copper sheet 40 is soldered to the surface of brazing layer 20, with the solder paste forming a solder layer 30.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A method for affixing a metal sheet to a carbon structure, comprising:
applying a brazing material to a surface of the carbon structure;
brazing the brazing material and the carbon structure to form a brazing layer on the surface of the carbon structure; and
soldering the metal sheet to the brazing layer.

2. The method of claim 1, further comprising cleaning the surface of the carbon structure prior to applying the brazing material.

3. The method of claim 1, wherein applying a brazing material includes screening printing the brazing material to the surface of the carbon structure.

4. The method of claim 1, wherein applying a brazing material includes spraying the brazing material onto the surface of the carbon structure.

5. The method of claim 1, wherein brazing the brazing material and the carbon structure comprises placing the carbon having the brazing material applied thereon into an environment having a vacuum degree of 1.0×10⁻¹ Pa or greater and a predetermined temperature of 800° C. or greater.

6. The method of claim 5, wherein brazing the brazing material and the carbon structure further comprises increasing the temperature of the environment at a rate between 10° C. and 20° C. per minute until the predetermined temperature is reached.

7. The method of claim 1, wherein brazing the brazing material and the carbon structure comprises brazing the brazing material and the carbon structure in a protective atmosphere furnace having a temperature of 800° C. or greater.

8. The method of claim 1, wherein soldering the metal sheet to the brazing layer comprises:
applying a solder material to a surface of the brazing layer;
placing the metal sheet over the solder material; and
placing the carbon structure and metal sheet into an environment having a temperature between 130° C. and 350° C. for a time interval between 2 minutes and 10 minutes.

9. The method of claim 8, wherein applying a solder material includes placing a solid sheet of the solder material having a shape corresponding to a shape of the carbon structure.

10. The method of claim 8, wherein applying a solder material includes applying a solder paste or a solder powder to the surface of the brazing layer.

11. The method of claim 8, wherein applying solder material includes screen printing the brazing layer onto the surface of the carbon structure.

12. An assembly comprising a carbon structure and a metal sheet, comprising:
a brazing layer disposed on a surface of the carbon structure, wherein the brazing layer is formed by brazing a brazing material on the surface of the carbon structure; and
a solder layer disposed on a surface of the brazing layer and binding the metal sheet to the brazing layer.

13. The assembly of claim 12, wherein the brazing layer comprises a reaction layer adjacent to the carbon structure, and a binding layer adjacent to the solder layer, wherein the reaction layer is formed through chemical reactions between the brazing material and carbon, and the binding layer is formed through reactions of the brazing material elements.

14. A method for metalizing a surface of a carbon structure, comprising:
applying a brazing material to a surface of the carbon structure; and
brazing the brazing material and the carbon structure.

15. The method of claim 14, further comprising cleaning the surface of the carbon structure prior to applying the brazing material, wherein cleaning comprises performing at least one of the following: grinding the surface of the carbon structure, washing the carbon structure in alcohol using a means for generating ultrasonic waves, immersing carbon structure in acetone, and drying the carbon structure.

16. The method of claim 14, wherein the brazing material is applied to the surface of the carbon structure using screen printing or spraying.

17. The method of claim 14, wherein brazing the brazing material and the carbon structure comprises placing the carbon having the applied brazing material into an environment having a vacuum degree of 1.0×10⁻¹ Pa or greater, and a target temperature of 800° C. or greater.

18. The method of claim 17, wherein the environment is configured is configured to increase in temperature at a rate between 10° C. and 20° C. a minute until the target temperature is reached.

19. The method of claim 14, wherein brazing the brazing material and the carbon structure comprises brazing the brazing material and carbon structure in an protective atmosphere furnace having a temperature of 800° C. or greater.

20. The method of claim 14, wherein the brazed brazing material forms brazing layer comprising a reaction layer adjacent to the carbon structure, and a binding layer adjacent to the solder layer, wherein the reaction layer is formed through chemical reactions between the brazing material and carbon, and the binding layer is formed through reactions of the brazing material elements.
